(19) United States
(12) Patent Application Publication
(10) Pub. No.: US 2026/0145530 A1
(43) Pub. Date: May 28, 2026

(54) ADAPTIVE HUMAN MACHINE INTERFACE

(71) Applicant: GM Global Technology Operations LLC, Detroit, MI (US)

(72) Inventors: Bijaya Aryal, Macomb Twp., MI (US); Aravind Gangumalla, Novi, MI (US); Vikramaditya Nimmagadda, Washington, MI (US); Arun Adiththan, Sterling Heights, MI (US)

(21) Appl. No.: 18/958,356

(22) Filed: Nov. 25, 2024

(51) Int. Cl. B60K 35/65; G06N 3/0442

(52) U.S. Cl. CPC B60K 35/65; G06N 3/0442; B60K 2360/1438; B60K 2360/731

(57) ABSTRACT

A vehicle includes a set of vehicle sensors in communication with a controller such that output signals of each sensor are provided to the controller. The set of sensors are configured to detect at least one vehicle condition. A human machine interface system for the vehicle includes a touchscreen display in communication with a controller. The controller includes a vehicle operator identification module and a human machine interface module. The human machine interface module is configured to cause the touchscreen display to display a human machine interface, accumulate a machine learning training data set based on user interactions with the human machine interface, train a machine learning system using the training data set, and automatically adapt the displayed human machine interface based on the trained machine learning system.

The subject disclosure relates to vehicles, and in particular to human machine interface systems including a capability to adapt based on particular interactions of a user.

Vehicles typically include multiple human machine interface systems (HMIs) that allow a user to interact with, and control, one or more corresponding vehicle systems. One typical human machine interface is a display presented on a touchscreen. Touchscreen displays allow buttons and other interactable elements to be displayed and interacted with by a user. In order to ensure the most usability, existing HMIs for touchscreen display interfaces are typically designed for the average user and/or the average use case.

However, every user is distinct and will have their own interaction patterns and preferences. In most cases, the HMI design for the average user provides a good enough interface. However, such an interface is not ideal or optimized for the specific user without the user having to put in substantial amounts of effort to identify and modify the HMI. In addition, in some cases a user may have narrow uses or specific preferences that are not accommodated by the design for the average user.

Accordingly, it is desirable to provide a HMI system for a vehicle touchscreen display that adaptively changes to meet the interaction types and preferences of a specific user without requiring the user to engage in a time consuming and difficult manual HMI modification process.

### SUMMARY

In one exemplary embodiment a vehicle includes vehicle sensors in communication with a controller such that output signals of each sensor are provided to the controller. The sensors are configured to detect at least one vehicle condition. A human machine interface system for the vehicle includes a touchscreen display in communication with a controller. The controller includes a vehicle operator identification module and a human machine interface module. The human machine interface module is configured to cause the touchscreen display to display a human machine interface, accumulate a machine learning training data set based on user interactions with the human machine interface, train a machine learning system using the machine learning training data set, and automatically adapt the displayed human machine interface based on the trained machine learning system.

In addition to one or more of the features described herein the controller further includes at least one data connection to at least one remote data source.

In addition to one or more of the features described herein the remote data source includes a processor set configured to at least partially implement training the machine learning system using the machine learning training data set and automatically adapting the displayed human machine interface based on the trained machine learning system.

In addition to one or more of the features described herein the at least one remote data source includes a data storage of at least one vehicle condition.

In addition to one or more of the features described herein accumulating the machine learning training data set based on user interactions with the human machine interface comprises monitoring vehicle operator interactions with the human machine interface and extracting at least one machine learning feature from each interaction.

In addition to one or more of the features described herein the vehicle operator interactions include voice interactions, touch interactions, eye tracking interactions, and gesture interactions.

In addition to one or more of the features described herein each feature defines a single interaction and a set of conditions associated with the interaction.

In addition to one or more of the features described herein the set of conditions includes at least one immediately prior interaction.

In addition to one or more of the features described herein the set of conditions includes at least one immediately subsequent interaction.

In addition to one or more of the features described herein each feature is a same data format as each other feature.

In addition to one or more of the features described herein the set of conditions includes a plurality of features cotemporaneous with the interaction, with the plurality of features cotemporaneous with the interaction including vehicle speed, seat position, driver position, weather condition, ambient lighting, time of day, direction of travel and traffic conditions.

In addition to one or more of the features described herein the human machine interface module is further configured to continuously update the displayed human machine interface subsequent to adapting the displayed human machine interface by monitoring interactions and conditions and updating the machine learning training data set using features defining the subsequent interactions.

In addition to one or more of the features described herein continuously updating the displayed human machine interface subsequent to adapting the displayed human machine interface further includes identifying gaps in at least one goal of the adapted displayed human machine interface and a logged interaction with the adapted displayed human machine interface.

In addition to one or more of the features described herein automatically adapting the displayed human machine interface based on the trained machine learning system comprises at least one of altering a spacing between icons, altering a size of one or more icons, altering a brightness of one or more icons, altering a size of a touchzone, and altering options in a menu selection system.

In addition to one or more of the features described herein automatically adapting the displayed human machine interface comprises altering options in the menu selection system, and wherein altering options in the menu selection system comprises hiding at least one option.

In addition to one or more of the features described herein the machine learning system is a long short term memory (LSTM) system.

In another exemplary embodiment a method for adapting a human machine interface based on user interactions logs user interactions with a human machine interface. Each logged user interaction is converted into a corresponding machine learning feature and each machine learning feature is saved in a feature set. The feature set is provided to a machine learning system as a training data set and the machine learning system is trained using the training data set. At least one element of the human machine interface is altered based on an output of the at least one trained machine learning system.

In addition to one or more of the features described herein each feature defines a single interaction and a set of conditions associated with the interaction.

In addition to one or more of the features described herein the set of conditions includes a plurality of features cotemporaneous with the interaction, with the plurality of features cotemporaneous with the interaction including vehicle speed, seat position, driver position, weather condition, ambient lighting, time of day, direction of travel and traffic conditions.

In addition to one or more of the features described herein altering at least one element of the human machine interface comprises at least one of altering a spacing between icons, altering a size of one or more icons, altering a brightness of one or more icons, altering a size of a touchzone, and altering options in a menu selection system.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an exemplary vehicle including an adaptive human machine interface system (HMI);

FIG. 2 is an example touch screen HMI;

FIG. 3 is a process for automatically adapting the example touch screen HMI of FIG. 2 using a machine learning based process;

FIG. 4 is an example machine learning architecture used with the process of FIG. 3; and

FIG. 5 is a set of HMI adaptations capable of being implemented by the process of FIG. 3.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term controller refers to a system including a processor and a memory. The system can be a dedicated controller, a general controller including subprocesses and modules for implementing the described control functions, a network of local processors and memories configured to work cooperatively to implement the described control functions, a combination of local and remote processors and memories configured to work cooperatively to implement the described functions, cloud computing systems, or any similar system where at least one processor and a memory are configured to implement the described control function.

In a general example of the systems described herein, interactions between a user and a vehicle are tracked using a controller. In addition to the types of interactions, various conditions cotemporaneous with the interactions (e.g., vehicle speed, weather conditions, lighting, traffic, etc.) are tracked and associated with the particular interactions. Features are extracted from the tracked interactions and associated conditions and the features are then used to train a machine learning (ML) model. The output of the ML model is used to generate modifications to a default HMI, thereby creating a personalized graphical user interface (GUI) for the user. The personalized graphical user interface is provided to the human machine interface system (HMI) which is then adapted to utilize the personalized graphical user interface.

In some examples, after the adapted HMI is implemented, the interaction patterns with the adapted HMI are continuously monitored to identify gaps in the adapted HMI where the user has difficulty interacting in the intended manner. The incidents relating to the gaps are then used to extract features, and the features are used to retrain the ML model. This in turn allows a new, updated, adapted HMI to be generated and provided to the HMI.

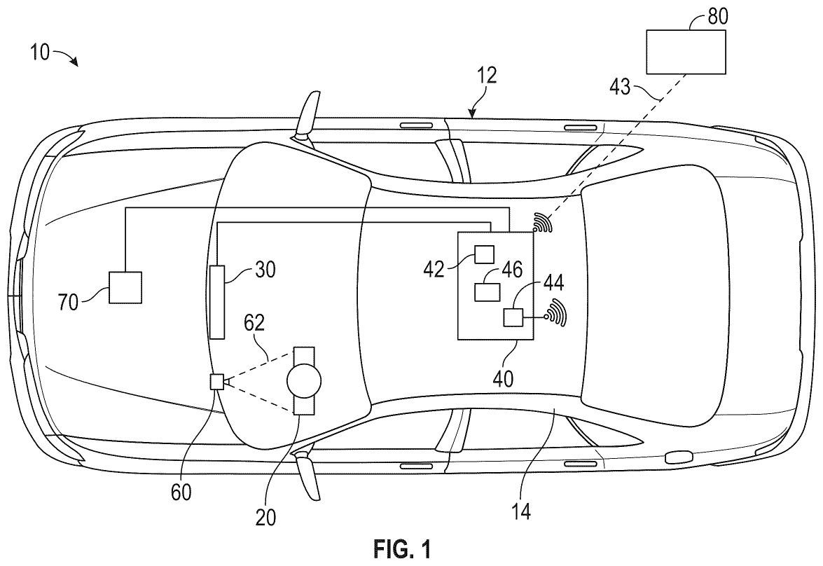

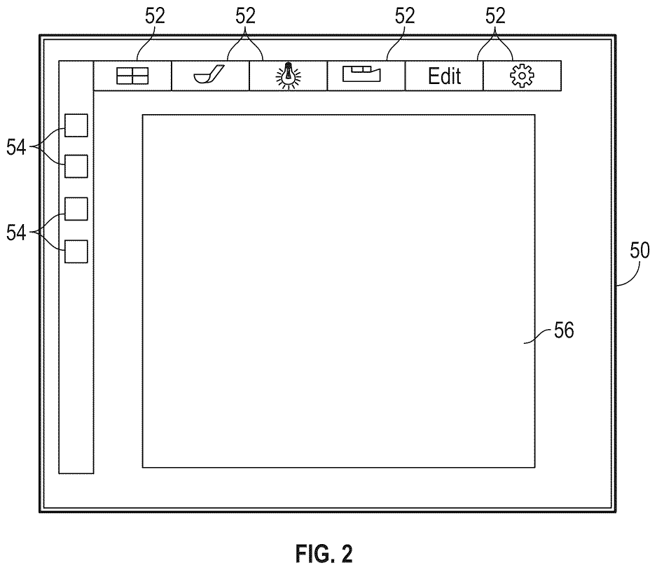

In accordance with an exemplary embodiment, FIG. 1 illustrates a schematic view of a vehicle 10, including a body 12 with an internal passenger compartment 14. FIG. 2 illustrates a human machine interface 50. A vehicle operator 20 is positioned in a driver's seat and operates the vehicle 10. The vehicle operator 20 interacts with some vehicle functions using a touchscreen display 30 which is connected to a controller 40. The touchscreen display 30 displays the human machine interface 50, and the vehicle operator 20 is able to interact with the controller 40 by touching various elements on the human machine interface 50.

The controller 40 includes a driver identification module 42 able to identify a unique vehicle operator 20. In one example, the unique vehicle operator 20 is identified via visual recognition provided by a camera 60 with the camera 60 defining a field of view 62 including the vehicle operator 20. In alternative examples, the driver identification module 42 may identify the unique vehicle operator 20 using other processes including driver login, driving style recognition, token identification (e.g. a connection with a driver's cell phone) or any similar methodology.

The vehicle 10 further includes sensors 70, with the sensors 70 monitoring vehicle operations and conditions including speed, revolutions per minute, ambient temperature, ambient lighting, external temperature and the like. Any conventional sensor suitable for detecting a corresponding feature may be used, with the sensor values being provided to the controller 40.

The controller 40 includes a wireless connection 43 for connecting to a remote computing system 80. The remote computing system 80 can include data sources storing data related to vehicle conditions, such as weather tracking databases, map systems and the like as well as access to networked processing through one or more remote processing centers. The one or more remote processing centers allow computationally intense processes or portions of processes to be performed off the vehicle 10, thereby allowing the processors within the controller 40, or in other vehicle elements to have lower requirements.

In some examples, the controller 40 includes a global navigation satellite system (GNSS) 44. The GNSS 44 uses satellite positioning to identify a global position of the vehicle 10.

The human machine interface 50 displayed on the touchscreen display 30 is generated and controlled by an HMI module 46 in the controller 40. The HMI module 46 initially provides a default human machine interface 50 to the touchscreen display 30, with the human machine interface 50 defining multiple icons 52, application selectors 54 and a primary display portion 56 (referred to collectively as elements 52, 54, 56). Each of the elements 52, 54, 56 has a defined height and width, as well as a defined placement on the HMI 50. As used herein, height refers to a vertical axis on the HMI 50, and width refers to a horizontal axis on the HMI 50. In one example, the default height width and placement is optimized for an average user.

In alternate examples, the elements 52, 54, 56 may include any number of additional elements and/or element types including but not limited to, scroll bars, partitioned primary sections 56, drop down menus, or any other graphical user interface (GUI) element(s).

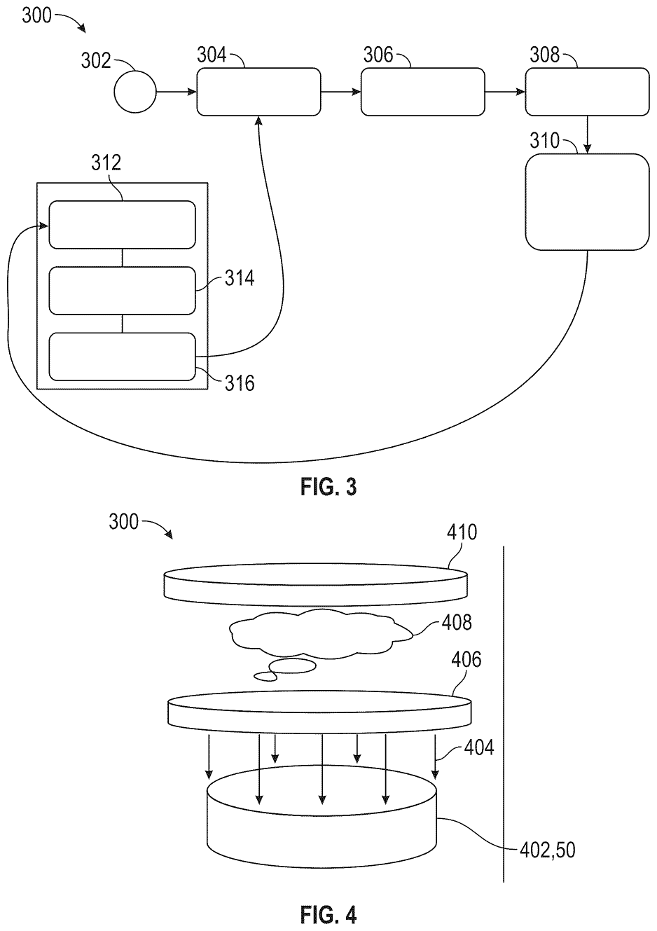

In addition to the default configuration of the HMI 50, the HMI module 46 includes a process for adapting the HMI 50 for a specific user (vehicle operator 20). With continued reference to FIGS. 1 and 2, FIG. 3 illustrates a process 300 for modifying the default human machine interface 50 to a specific user identified using the driver identification module 42.

Each time a user interacts with the HMI 50, a user interaction 302 occurs. The controller 40 identifies the user interaction 302 and logs the interaction in a log interaction patterns step 304. The logged interaction includes the specific interaction (e.g. touch a first element) and, any available conditions occurring contemporaneously with the specific interaction. By way of example, the conditions can include any or all of current weather, current traffic conditions, current ambient lighting, current geolocation of the vehicle, current speed of the vehicle, time of day, direction of travel, position of a driver (e.g. a distance of the driver from a steering unit or a display), a seat position, as well as any other available pertinent conditions.

Furthermore, in some examples, the conditions can include precursor interactions and/or subsequent interactions. By way of example, when the vehicle operator 20 canceled a previous selection and immediately performed the current interaction a precursor interaction condition would define that the interaction is a correction of an immediately previous interaction. Similarly, when the vehicle operator 20 immediately follows the interaction with a subsequent interaction such as selecting an element in a submenu, the subsequent selection can be stored as a condition.

In addition to the direct conditions, each interaction may also include one or more secondary conditions such as age-based driver preferences and driving habits, profession-based driving habits, and the approach taken by the vehicle operator to implementing the interaction (each number of fingers used to tap, angle of fingers, pressure of tap, etc.).

In an initial iteration, the process 300 logs a threshold number of interactions in the log interaction patterns step 304 before proceeding to a process log and extract features step 306. The particular threshold depends on the specific model implemented and a number of interactions required to exceed a confidence threshold for training the model on the data set. The interactions can be a voice interaction, a touch interaction, an eye tracking interaction, a gesture interaction, or any other type of interaction with the HMI 50.

Once the threshold has been reached, the process 300 extracts features from the interaction patterns in step 306. A feature is a singular defined data point identifying the interaction, and the conditions associated with the interaction. All features are presented as an identical format, effectively normalizing all the logged interactions into a single data format that can be provided as a training set for a machine learning system. In one example, the feature can match the feature defined in the following feature representation:

Input Layer:

```
  {
    “interaction id”: “####”,
    “screen width”: “640”,
    “screen height”: “480”,
    “user id”: ““#####”,
    “timestamp”: ““######”,
    “driver”: “y”,
    “right_handed”: “n”,
    “hand (or) finger tracking”: {
      “x”: “10”,
      “y”: “10”,
      “touch_detected”: “n”,
      “speed”: “2”,
  },
    “eyegaze_tracking” : {
      “x”: “10”,
      “y”: “10”,
      “pupil diameter”: 1,
      “Fixation duration”: 10
  }
}
```

The Input layer refers to the set of features. Within each feature, the interaction id identifies the type of interaction (e.g. screen tap), the screen width condition identifies a width of the HMI 50 in pixels, the screen height identifies the height of the HMI 50 in pixels, the user ID identifies the specific vehicle operator 20 performing the interaction, the timestamp identifies the time the interaction occurs, the driver identifies whether the interaction was performed by the driver or someone else, the right handed condition identifies whether the driver is right handed, the hand or finger tracking condition identifies a position of the finger touch on the HMI 50 in a vertical (x) axis/height and in a horizontal (y) axis/width, the touch detected condition identifies whether a touch was determined, the speed condition identifies the speed of the touch in ms, the eyegaze tracking condition identifies what portion of the HMI 50 the vehicle operator 20 is directing their gaze toward, the diameter of the vehicle operator's pupils and how low the vehicle operator was looking at the HMI 50.

The provided pseudocode feature is a single example implementation, and a practical implementation can include any number of additional conditions quantifying the conditions applying to the type of interaction.

After processing all of the interactions into features, the features are combined into a machine learning training data set, and the training data set is used to train a machine learning system in a train ML system step 308. In one example, the machine learning system is a long short term memory (LSTM) machine learning algorithm. LSTM algorithms are particularly suited for the process 300 due to their ability to accurately predict next actions in a time series. In this particular implementation, the next action is the likely next interaction with the human machine interface 50, and this probability of next actions is used to generate changes to the human machine interface 50 in a generate personalized GUI asset properties step 310.

In general implementations, the output of the machine learning algorithm is one of a probability vector for selecting a specific element located adjacent to each other or a heat map for the next interaction being an interaction with a particular portion of the human machine interface 50. This output is then applied to one or more rules to generate the changes indicated by the output.

The personalized GUI includes changes to the elements 52, 54, 56 making up the HMI 50. The changes can include dimensional changes, positional changes, menu ordering, and the like. The resultant defined GUI for the human machine interface 50 replaces the existing HMI 50 in an update asset properties step 312. Once updated, the new human machine interface 50 is presented to the vehicle operator 20, and interactions with the updated human machine interface 50 are monitored in a monitor updated HMI step 314.

During step 314, interactions are logged in the same manner as in the initial log interaction patterns step 304. In addition, the interactions are analyzed for gaps in a quantify gaps step 316. Gaps occur when one or more elements of the HMI 50 were adapted in order to achieve a targeted goal but the targeted goal is not reached. By way of example, when the targeted goal is reducing a number of taps to engage a vehicle feature to 1, and the vehicle operator 20 is still typically engaging in 2 taps, a gap of 1 tap exists even though the reduction to a two tap requirement is still an improvement over the default human machine interface 50.

After a threshold number of interactions, the logged interactions and quantified gaps are provided to step 304, where the process 300 reiterates. The threshold number may vary depending on the particular implementation and conditions and is set to a number required for a pattern in the logged interactions to emerge. Second and subsequent iterations do not require establishment of sufficient interactions to generate a full training set, as the initially developed training set is supplemented with the subsequent interactions.

With continued reference to FIGS. 1-3, FIG. 4 visually illustrates the process 300, with the default HMI 50, 402 being subjected to multiple user interactions 404. The user interactions 404 are logged and processed into features in a user interaction layer 406 and the features are provided to the machine learning system 408. The machine learning system 408 generates the new adapted HMI 410, which replaces the default HMI 402, 50. In some examples, the new adapted HMI 410 may be further deployed to a central data system and/or other users, thereby providing more information for a training set and allow a default HMI to be further refined.

With continued reference to FIGS. 1-4, FIG. 5 illustrates multiple possible adaptations 510, 520, 530, 540 that can be made to the HMI 50, and in particular to specific elements of the HMI 50.

In the first adaptation 510, a set of icons is included in a row 514, with each icon having a delineated section with a set width 512. In the base HMI 50, each icon is contained with a section having the same width 512 as each other icon. In the transformed section the width 512 of the sections varies, and the order of the icons has been altered in order to emphasize more commonly used icons (square and triangle) and de-emphasize less commonly used icons (circle and diamond). This adaption may be performed in order to increase the visibility of the more commonly used icons and decrease a number of corrections required due to the user inadvertently touching the wrong icon, or inadvertently touching multiple icons.

In a second adaptation 520, an individual icon is contained within a defined space, and the size of the icon within that defined space 522 can be increased or decreased. This modification increases the visibility and/or legibility of the icon and can be implemented when the output of the machine learning provides a goal of decreasing a number of incorrect selections.

In a third adaptation 530, the element includes a defined touch zone 532. The touch zone is an area of the HMI 50 that registers as a touch for the corresponding element 52, 54, 56 when the vehicle operator 20 touches the screen. In the third adaptation 530, one or more of the dimensions of the touch zone 532 is increased, thereby increasing the real estate of the HMI 50 that can be touched to correspond to a selection of any contained element 52, 54.

In a fourth adaptation 540, the element includes multiple selection boxes 542, each of which includes additional submenus. In addition, a scroll bar 544 allows the vehicle operator 20 to scroll up and down, and change which of the selection boxes 542 is on the screen. When the machine learning output indicates that certain selections are not used, these selection boxes 542 can be hidden or included within other selection boxes and the nesting order of the selection boxes 542 is changed. This in turn allows a full listing of selection boxes 542 to appear without requiring scrolling, and allows for selections that are used more often to be placed at higher levels within the selection boxes 542.

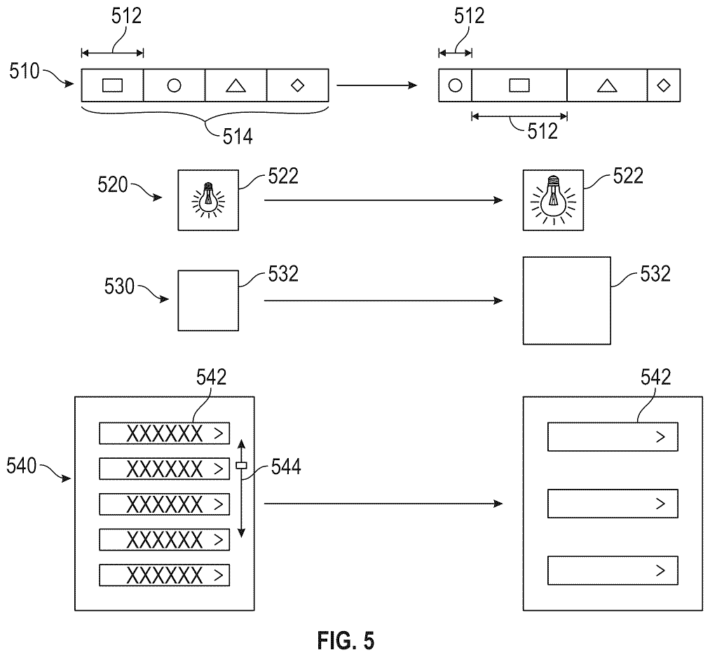

The adaptations 510, 520, 530, 540 described an illustrated in FIG. 5 are exemplary in nature and are not considered exhaustive. In one practical implementation the machine learning output defines goals of the adaptation, and the process 300 can apply rules to convert the goals into practical adaptations. Further adaptions can include, in some examples, increasing or decreasing a brightness of an element, removing or hiding elements, or any similar type of adaption.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
vehicle sensors in communication with a controller such that output signals of each vehicle sensor are provided to the controller, the vehicle sensors being configured to detect at least one vehicle condition;
a human machine interface system including a touchscreen display, the touchscreen display being in communication with a controller;
the controller including a vehicle operator identification module and a human machine interface module; and
the human machine interface module being configured to cause the touchscreen display to display a human machine interface, accumulate a machine learning training data set based on user interactions with the human machine interface, train a machine learning system using the machine learning training data set and automatically adapt the displayed human machine interface based on the trained machine learning system.

2. The vehicle of claim 1, wherein the controller further includes at least one data connection to at least one remote data source.

3. The vehicle of claim 2, wherein the remote data source includes a processor set configured to at least partially implement training the machine learning system using the machine learning training data set and automatically adapting the displayed human machine interface based on the trained machine learning system.

4. The vehicle of claim 2, wherein the at least one remote data source includes a data storage of at least one vehicle condition.

5. The vehicle of claim 1, wherein accumulating the machine learning training data set based on user interactions with the human machine interface comprises monitoring vehicle operator interactions with the human machine interface and extracting at least one machine learning feature from each interaction.

6. The vehicle of claim 5, wherein the vehicle operator interactions include voice interactions, touch interactions, eye tracking interactions, and gesture interactions.

7. The vehicle of claim 5, wherein each feature defines a single interaction and a set of conditions associated with the interaction.

8. The vehicle of claim 7, wherein the set of conditions includes at least one immediately prior interaction.

9. The vehicle of claim 7, wherein the set of conditions includes at least one immediately subsequent interaction.

10. The vehicle of claim 7, wherein each feature is a same data format as each other feature.

11. The vehicle of claim 7, wherein the set of conditions includes a plurality of features cotemporaneous with the interaction, with the plurality of features cotemporaneous with the interaction including vehicle speed, seat position, driver position, weather condition, ambient lighting, time of day, direction of travel and traffic conditions.

12. The vehicle of claim 7, wherein the human machine interface module is further configured to continuously update the displayed human machine interface subsequent to adapting the displayed human machine interface by monitoring logging interactions and conditions and updating the machine learning training data set using features defining subsequent interactions.

13. The vehicle of claim 12, wherein continuously updating the displayed human machine interface subsequent to adapting the displayed human machine interface further includes identifying gaps in at least one goal of the displayed human machine interface and a logged interaction with the adapted displayed human machine interface.

14. The vehicle of claim 1, wherein automatically adapting the displayed human machine interface based on the trained machine learning system comprises at least one of altering a spacing between icons, altering a size of one or more icons, altering a brightness of one or more icons, altering a size of a touchzone, and altering options in a menu selection system.

15. The vehicle of claim 14, wherein automatically adapting the displayed human machine interface comprises altering options in the menu selection system, and wherein altering options in the menu selection system comprises hiding at least one option.

16. The vehicle of claim 1, wherein the machine learning system is a long short term memory (LSTM) system.

17. A method for adapting a human machine interface based on user interactions, the method comprising:
logging user interactions with a human machine interface;
converting each logged user interaction into a corresponding machine learning feature and saving each machine learning feature in a feature set;
providing the feature set to a machine learning system as a training data set and training the machine learning system using the training data set;
altering at least one element of the human machine interface based on an output of the at least one trained machine learning system.

18. The method of claim 17, wherein each feature defines a single interaction and a set of conditions associated with the single interaction.

19. The method of claim 18, wherein the set of conditions includes a plurality of features cotemporaneous with the single interaction, with the plurality of features cotemporaneous with the single interaction including vehicle speed, seat position, driver position, weather condition, ambient lighting, time of day, direction of travel and traffic conditions.

20. The method of claim 17, wherein altering at least one element of the human machine interface comprises at least one of altering a spacing between icons, altering a size of one or more icons, altering a brightness of one or more icons, altering a size of a touchzone, and altering options in a menu selection system.
